(19) United States
(12) Patent Application Publication
(10) Pub. No.: US 2006/0077031 A1
(43) Pub. Date: Apr. 13, 2006

(54) Concealed adjustable temperature switch

(76) Inventor: Grace Lee, Chia Yi Hsien (TW)

Correspondence Address: STITES & HARBISON PLLC, 1199 NORTH FAIRFAX STREET, SUITE 900, ALEXANDRIA, VA, 22314, US

(21) Appl. No.: 10/961,196

(22) Filed: Oct. 12, 2004

(51) Int. Cl. H01H 37/52

(52) U.S. Cl. 337/333

(57) ABSTRACT

A concealed adjustable temperature switch is electrically connected to a heating member. The concealed adjustable temperature switch includes a fixed plate with a screw hole, an adjusting block having an outer threading threadedly engaged with the screw hole of the fixed plate, a bimetal plate that has different bending extents at different temperatures, and a metal plate. A positioning ring is securely mounted on the adjusting block to turn therewith. Two spaced stops are provided to stop a projection of the positioning ring, thereby limiting turning of the adjusting block.

### BACKGROUND OF THE INVENTION

1. Field of the Invention

The present invention relates to an adjustable temperature switch. In particular, the present invention relates to a concealed adjustable temperature switch for an electric appliance such as a hot melt glue gun for preventing damage.

2. Description of the Related Art

A typical hot melt glue gun comprises a concealed adjustable temperature switch in a body thereof for adjusting the temperature for melting a solid glue stick into liquid. FIG. 5 of the drawings is a conventional hot melt glue gun comprising a body 4′ and a concealed adjustable temperature switch 1′ that is connected by wires 2′ to a heating member 3′. The adjustable temperature switch 1′ includes an adjusting block 11′ with an outer threading 111′, a fixed plate 12′ with a screw hole 121′, a bimetal plate 13′, and a metal plate 14′. The bimetal plate 13′ includes a first plate and a second plate that are bonded together, wherein the bimetal plate 13′ has different bending extents at different temperatures. The outer threading 111′ of the adjusting block 11′ is threadedly engaged with the screw hole 121′ of the fixed plate 12′. The bimetal plate 13′ is electrically connected to an electrode, and the metal plate 14′ is electrically connected to the other electrode.

A tool T can be extended into the body 4′ to turn the adjusting block 11′, moving the adjusting block 11′ toward or away from the bimetal plate 13′ to thereby cause the bimetal plate 13′ to be in tight contact or loose contact with the metal plate 14′. When the adjusting block 11′ is turned in a direction, the adjusting block 11′ moves toward the bimetal plate 13′ and causes the bimetal plate 13′ to be in loose contact with the metal plate 14′. In this case, slight bending of the bimetal plate 13′ at a relatively low temperature is sufficient to cause disengagement of the bimetal plate 13′ from the metal plate 14′, resulting in an open circuit. Thus, electricity supply to the heating member 3′ is cut off.

On the other hand, when the adjusting block 11′ is turned in a reverse direction, the adjusting block 11′ moves away from the bimetal plate 13′ and causes the bimetal plate 13′ to be in tight contact with the metal plate 14′. In this case, greater bending of the bimetal plate 13′ at a relatively high temperature is required to cause disengagement of the bimetal plate 13′ from the metal plate 14′ to cut off electricity supply to the heating member 3′.

However, since the adjustable temperature switch 1′ is concealed in the body 4′, the user could not know the contact between the bimetal plate 13′ and the metal plate 14′. In a case that the user misjudges a tight contact as a loose contact and turns the adjusting block 11′ in the tightening direction, the bimetal plate 13′ will be in an overtight contact with the metal 14′ such that great bending of the bimetal plate 13′ still could not cause disengagement from the metal 14′. As a result, overheating of the heating member 3′ occurs, leading to overload and damage. Further, excessive rotation of the adjusting block 11′ may cause disengagement from the screw hole 121′ of the fixed plate 12′, leading to falling of the adjusting block 11′. On the other hand, if a loose contact is misjudged as a tight contact, the adjusting block 11′ is turned in the wrong direction such that the bimetal plate 13′ could not be in contact with the metal plate 14′, resulting in an undesired open circuit.

### SUMMARY OF THE INVENTION

An objective of the present invention is to provide a concealed adjustable temperature switch for preventing damage to an electric appliance due to overheat.

Another objective of the present invention is to provide a concealed adjustable temperature switch for preventing the adjusting block from being disengaged from the fixed plate.

A concealed adjustable temperature switch in accordance with the present invention is electrically connected to a heating member. The concealed adjustable temperature switch comprises a fixed plate with a screw hole, an adjusting block having an outer threading threadedly engaged with the screw hole of the fixed plate, a bimetal plate that has different bending extents at different temperatures, and a metal plate. The bimetal plate is electrically connected to one of two electrodes, and the metal plate is electrically connected to the other electrode. A positioning ring is securely mounted on the adjusting block to turn therewith. The positioning ring is fixed on the adjusting block by a fixing ring. The positioning ring includes a projection. Two spaced stops are provided to stop the projection of the positioning ring, thereby limiting turning of the adjusting block.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a concealed adjustable temperature switch in accordance with the present invention.

FIG. 2 is a hot melt glue gun with the concealed adjustable temperature switch in accordance with the present invention.

FIG. 3 is a front view illustrating adjusting of the concealed adjustable temperature switch in a direction.

FIG. 4 is a view similar to FIG. 3, illustrating adjusting of the concealed adjustable temperature switch in a reverse direction.

FIG. 5 is a sectional view of a hot melt glue gun with a conventional concealed adjustable temperature switch.

### DETAILED DESCRIPTION OF THE PREFERRED EMBODIMENT

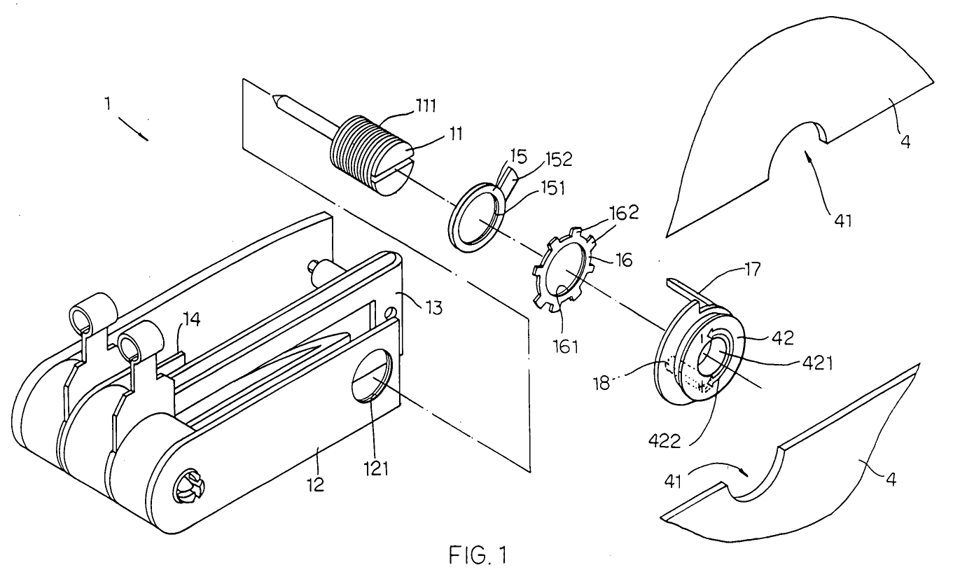

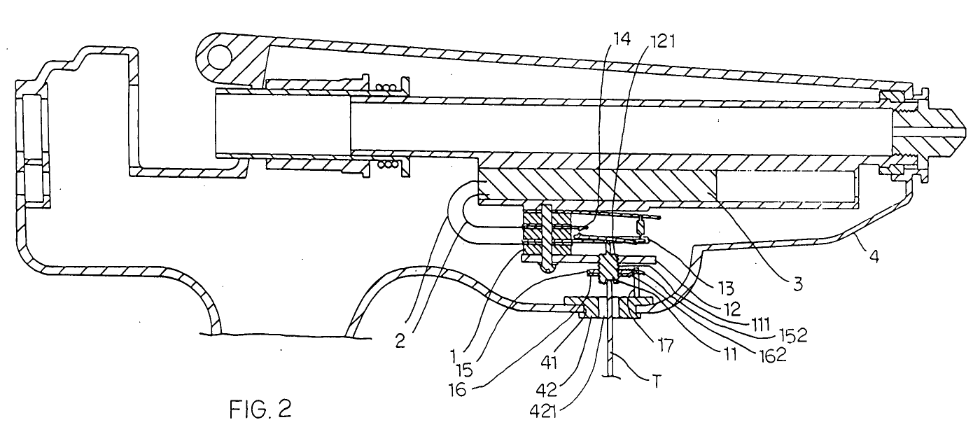

FIG. 2 illustrates a holt melt glue gun comprises a body 4 and a concealed adjustable temperature switch 1 mounted in the body 4 and electrically connected by wires 2 to a heating member 3 in the body 4. Referring to FIGS. 1 and 2, the adjustable temperature switch 1 includes an adjusting block 11 with an outer threading 111, a fixed plate 12 with a screw hole 121, a bimetal plate 13, and a metal plate 14. The bimetal plate 13 includes a first plate and a second plate that are bonded together, wherein the bimetal plate 13 has different bending extents at different temperatures. The outer threading 111 of the adjusting block 11 is threadedly engaged with the screw hole 121 of the fixed plate 12. The bimetal plate 13 is electrically connected to an electrode, and the metal plate 14 is electrically connected to the other electrode.

A tool T can be extended into the body 4 to turn the adjusting block 11, moving the adjusting block 11 toward or away from the bimetal plate 13 to thereby cause the bimetal plate 13 to be in tight contact or loose contact with the metal plate 14. When the adjusting block 11 is turned in a direction, the adjusting block 11 moves toward the bimetal plate 13 and causes the bimetal plate 13 to be in loose contact with the metal plate 14. In this case, slight bending of the bimetal plate 13 at a relatively low temperature is sufficient to cause disengagement of the bimetal plate 13 from the metal plate 14, resulting in an open circuit. Thus, electricity supply to the heating member 3 is stopped.

On the other hand, when the adjusting block 11 is turned in a reverse direction, the adjusting block 11 moves away from the bimetal plate 13 and causes the bimetal plate 13 to be in tight contact with the metal plate 14. In this case, greater bending of the bimetal plate 13 at a relatively high temperature is required to cause disengagement of the bimetal plate 13 from the metal plate 14 to cut off electricity supply to the heating member 3.

Of more importance, the concealed adjustable temperature switch 1 comprises a positioning ring 15, a fixing ring 16, and two stops 17 and 18. The positioning ring 15 includes a screw hole 151 threadedly engaged with the outer threading 111 of the adjusting block 11. Thus, the positioning ring 15 is securely mounted on the adjusting block 11. The positioning ring 15 further includes a projection 152.

The fixing ring 16 includes a screw hole 161 threadedly engaged with the outer threading 111 of the adjusting block 11. Thus, the positioning ring 15 is securely mounted on the adjusting block 11 and in contact with the positioning ring 15. A plurality of teeth 162 are formed on a circumference of the fixing ring 16. The projection 152 of the positioning ring 15 is aligned with a gap between two adjacent teeth 162. The two teeth 162 are bent to be respectively located on two sides of the projection 152, thereby securing the fixing ring 16 and the positioning ring 15 together. Thus, when the adjusting block 11 turns, the projection 152 moves along a circular path.

The stops 17 and 18 are spaced apart and located on two points of the circular path. In this embodiment, the stops 17 and 18 project from a plug 42 securely mounted in a hole 41 of the body 4. The plug 42 includes a hole 421 aligned with the adjusting block 11. A double-arrow indication mark 422 is provided on a front face of the plug 42.

The tool T can be extended through the hole 421 of the plug 42 into the body 4 for turning the adjusting block 11. The adjusting block 11 is moved to cause that the projection 152 of the positioning ring 15 is movable between the stops 17 and 18. When the adjusting block 11 is turned, e.g., clockwise, the electric appliance (e.g., a hot melt glue gun) can operate at a relatively high temperature environment. On the other hand, when the adjusting block 11 is turned counterclockwise, the electric appliance can operate at a relatively low temperature environment.

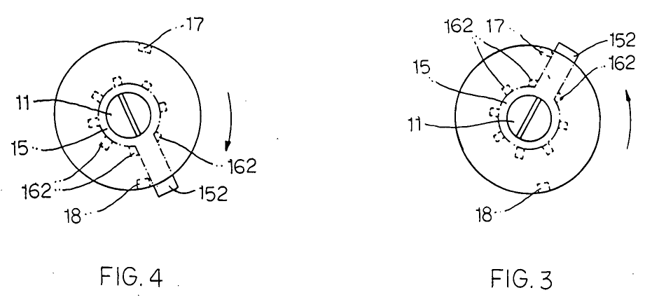

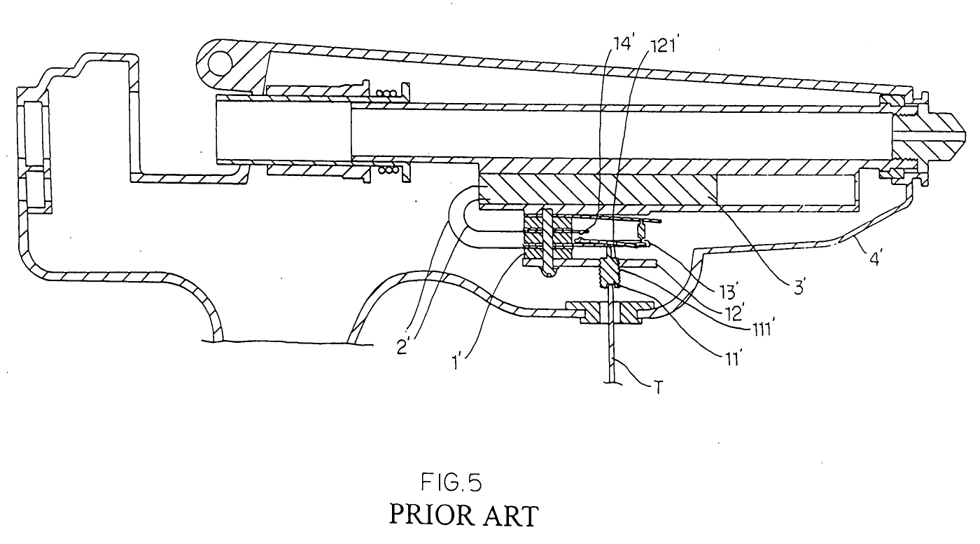

Referring to FIG. 3, when the electric appliance is to be used at a relatively low temperature environment, the adjusting block 11 is turned counterclockwise until the projection 152 of the positioning ring 15 is stopped by the stop 17. Thus, the adjusting block 11 is moved to a position to cause the bimetal plate 13 to be in loose contact with the metal plate 14. In this case, slight bending of the bimetal plate 13 at a relatively low temperature is sufficient to disengage the bimetal plate 13 from the metal plate 14, cutting off supply of electricity to the heating member 3.

Referring to FIG. 4, when the electric appliance is to be used at a relatively high temperature environment, the positioning ring 15 is turned clockwise until the projection 152 of the adjusting block 11 is stopped by the other stop 18. Thus, the adjusting block 11 is moved to a position to cause the bimetal plate 13 to be in tight contact with the metal plate 14. In this case, greater bending of the bimetal plate 13 at a relatively high temperature is required to disengage the bimetal plate 13 from the metal plate 14, cutting off supply of electricity to the heating member 3.

The user may follow the indication mark 422 to adjust the concealed adjustable temperature switch 1 in response to the needs. The positioning ring 15, the fixing ring 16, and the stops 17 and 18 prevent the adjusting block 11 from disengaging from the fixed plate 12 and prevent the electric appliance from being damaged.

Although a specific embodiment has been illustrated and described, numerous modifications and variations are still possible without departing from the essence of the invention. The scope of the invention is limited by the accompanying claims.

What is claimed is:

1. A concealed adjustable temperature switch electrically connected to a heating member, the concealed adjustable temperature switch comprising a fixed plate with a screw hole, an adjusting block having an outer threading threadedly engaged with the screw hole of the fixed plate, a bimetal plate that has different bending extents at different temperatures, and a metal plate, the bimetal plate being electrically connected to one of two electrodes, the metal plate being electrically connected to the other electrode, a positioning ring being securely mounted on the adjusting block to turn therewith, the positioning ring being fixed on the adjusting block by a fixing ring, the positioning ring including a projection, further including two spaced stops to stop the projection of the positioning ring, thereby limiting turning of the adjusting block.

2. The concealed adjustable temperature switch as claimed in claim 1 wherein the fixing ring includes two teeth having a gap therebetween, the teeth being bent to be respectively located on two sides of the projection, thereby securing the positioning ring and the fixing ring together.
